(19) United States
(12) Patent Application Publication
(10) Pub. No.: US 2017/0083958 A1
(43) Pub. Date: Mar. 23, 2017

(54) METHOD AND SYSTEM FOR ASSESSING PARKING CAPACITY

(71) Applicant: MasterCard International Incorporated, Purchase, NY (US)

(72) Inventors: Kenneth UNSER, Fairfield, CT (US); Harrison Reid SIEGEL, Glencoe, IL (US)

(73) Assignee: MASTERCARD INTERNATIONAL INCORPORATED, Purchase, NY (US)

(21) Appl. No.: 14/858,297

(22) Filed: Sep. 18, 2015

(51) Int. Cl. G06Q 30/02; G06F 17/30

(52) U.S. Cl. CPC G06Q 30/0284; G06F 17/30483

(57) ABSTRACT

A method for generating data estimates of parking metrics based on transaction behaviors includes: storing parking data correlations, each including parking metrics and correlated transaction behaviors; storing transaction data entries, each including a geographic location and a time; receiving a parking metric request, the request including a specific geographic area and time range; identifying a subset of transaction data entries where the included geographic location is within the specific geographic area and the included time within the time range; identifying transaction behaviors based on a number of transaction data entries in the subset s and data stored therein; identifying a parking data correlation where the included correlated transaction behaviors corresponds to the identified transaction behaviors; and transmitting the parking metrics included in the identified parking data correlation in response to the received parking metric request.

### FIELD

The present disclosure relates to the generating of data correlations between parking metrics and transaction behavior and use thereof in estimation of parking capacity and parking metrics for a given area based on purchase data.

### BACKGROUND

In heavily urbanized areas, such as in dense cities like New York City, Washington, D.C., and Chicago, and at places where a significant amount of people may visit, such as large shopping malls, arenas, stadiums, and concert venues, the ability to find parking may be extremely limited. Because of the demand for parking, many of these places include significant parking structures or areas, and will often only allow parking for a fee, in an effort to both limit the number of parkers and also to take advantage of the need for parking.

Unfortunately, even with the addition of fees and extra parking structures, it may still be difficult and time consuming, and in some instances completely impossible, to find an open parking spot. In such instances, a driver may spend a significant amount of time looking for a parking spot in various locations, time which could have been better spent by parking further away from their destination and walking, or taking public transportation or other alternative forms of transportation that, due to parking constraints, would have been faster.

In an effort to assist parkers with finding available parking spaces, many parking structures have begun to use methods for determining how many spaces are available within the structure. In some instances, the parking structure may use sensors on each parking space to identify occupancy, while, in other instances, the movement of vehicles in and out of the parking structure may be tracked. Unfortunately, such information is only obtainable for parking structures, is often only available for a single parking structure and not for parking in an area as a whole, and is often unavailable for different forms of parking, such as street parking. In addition, such information is often only available if the person attempting to park physically visits the parking structure, which, if no spaces are available, may result in a wasted trip for the person, who must then spend additional time trying to find a parking space elsewhere.

Thus, there is a need for a technical solution where parking metrics for a geographic area as a whole may be identified, which may include available parking in the area that is not limited to specific parking structures. In addition, there is a need for a technical solution where the parking metrics may be identified without analysis of individual parking spaces or parking structures specifically, as such methods may require significant expenditure of resources and development of complicated technology. Accordingly, the identification of parking metrics based on transaction behavior, which may be identified via data correlations generated between parking metrics and transaction behavior, may provide for a technical solution to the assessment of parking capacity for a geographic area.

### SUMMARY

The present disclosure provides a description of systems and methods for generating data correlations between parking metrics and transaction behavior and estimates of parking metrics based thereon.

A method for generating data correlations between parking metrics and transaction behavior includes: storing, in a first database of a processing server, a plurality of parking data entries, wherein each parking data entry includes at least a geographic area, a time and/or date, and one or more parking metrics; storing, in a second database of the processing server, a plurality of transaction data entries, wherein each transaction data entry includes data related to a payment transaction including at least a plurality of data elements including at least a first data element configured to store a geographic location and a second data element configured to store a time and/or date; receiving, by a receiving device of the processing server, a data correlation request, wherein the data correlation request includes a specific geographic area and a plurality of time and/or date ranges; executing, by a processor of the processing server, a first query on the first database to identify, for each time and/or date range of the plurality of time and/or date ranges, a corresponding parking data entry where the included geographic area corresponds to the specific geographic area and where the included time and/or date is within the respective time and/or date range; executing, by the processor of the processing server, a second query on the second database to identify, for each time and/or date range of the plurality of time and/or date ranges, a subset of transaction data entries where the geographic location stored in the included first data element is within the specific geographic area and where the time and/or date stored in the included second data element is within the respective time and/or date range; identifying, by the processor of the processing server, one or more transaction behaviors for each time and/or date range of the plurality of time and/or date ranges based on at least a number of transaction data entries included in the associated subset of transaction data entries and data stored in one or more of the plurality of data elements included in each transaction data entry included in the associated subset of transaction data entries; identifying, by the processor of the processing server, at least one data correlation between transaction behaviors and parking metrics based on a comparison of, for each time and/or date range of the plurality of time and/or date ranges, the one or more transaction behaviors identified for the associated subset of transaction data entries and the one or more parking metrics included in the corresponding parking data entry; and transmitting, by a transmitting device of the processing server, the identified at least one data correlation in response to the received data correlation request.

A method for generating data estimates of parking metrics based on transaction behaviors includes: storing, in a first database of a processing server, a plurality of parking data correlations, wherein each parking data correlation includes at least one or more parking metrics and one or more correlated transaction behaviors; storing, in a second database of the processing server, a plurality of transaction data entries, wherein each transaction data entry includes data related to a payment transaction including at least a plurality of data elements including at least a first data element configured to store a geographic location and a second data element configured to store a time and/or date; receiving, by a receiving device of the processing server, a parking metric request, wherein the parking metric request includes at least a specific geographic area and a time and/or date range; executing, by a processor of the processing server, a first query on the second database to identify a subset of transaction data entries where the included first data element stores a geographic location within the specific geographic area and where the included second data element stores a time and/or date within the time and/or date range; identifying, by the processor of the processing server, one or more transaction behaviors based on at least a number of transaction data entries included in the identified subset of transaction data entries and data stored in one or more of the plurality of data elements included in each transaction data entry included in the identified subset of transaction data entries; executing, by the processor of the processing server, a second query on the first database to identify a parking data correlation where the included one or more correlated transaction behaviors corresponds to the identified one or more transaction behaviors; and transmitting, by a transmitting device of the processing server, at least the one or more parking metrics included in the identified parking data correlation in response to the received parking metric request.

A system for generating data correlations between parking metrics and transaction behavior includes a first database, a second database, a receiving device, a processor, and a transmitting device of a processing server. The first database of a processing server is configured to store a plurality of parking data entries, wherein each parking data entry includes at least a geographic area, a time and/or date, and one or more parking metrics. The second database of the processing server is configured to store a plurality of transaction data entries, wherein each transaction data entry includes data related to a payment transaction including at least a plurality of data elements including at least a first data element configured to store a geographic location and a second data element configured to store a time and/or date. The receiving device of the processing server is configured to receive a data correlation request, wherein the data correlation request includes a specific geographic area and a plurality of time and/or date ranges. The processor of the processing server is configured to: execute a first query on the first database to identify, for each time and/or date range of the plurality of time and/or date ranges, a corresponding parking data entry where the included geographic area corresponds to the specific geographic area and where the included time and/or date is within the respective time and/or date range; execute a second query on the second database to identify, for each time and/or date range of the plurality of time and/or date ranges, a subset of transaction data entries where the geographic location stored in the included first data element is within the specific geographic area and where the time and/or date stored in the included second data element is within the respective time and/or date range; identify one or more transaction behaviors for each time and/or date range of the plurality of time and/or date ranges based on at least a number of transaction data entries included in the associated subset of transaction data entries and data stored in one or more of the plurality of data elements included in each transaction data entry included in the associated subset of transaction data entries; and identify at least one data correlation between transaction behaviors and parking metrics based on a comparison of, for each time and/or date range of the plurality of time and/or date ranges, the one or more transaction behaviors identified for the associated subset of transaction data entries and the one or more parking metrics included in the corresponding parking data entry. The transmitting device of the processing server is configured to transmit the identified at least one data correlation in response to the received data correlation request.

A system for generating data estimates of parking metrics based on transaction behaviors includes a first database, a second database, a receiving device, a processor, and a transmitting device of a processing server. The first database of a processing server is configured to store a plurality of parking data correlations, wherein each parking data correlation includes at least one or more parking metrics and one or more correlated transaction behaviors. The second database of the processing server is configured to store a plurality of transaction data entries, wherein each transaction data entry includes data related to a payment transaction including at least a plurality of data elements including at least a first data element configured to store a geographic location and a second data element configured to store a time and/or date. The receiving device of the processing server is configured to receive a parking metric request, wherein the parking metric request includes at least a specific geographic area and a time and/or date range. The processor of the processing server is configured to: execute a first query on the second database to identify a subset of transaction data entries where the included first data element stores a geographic location within the specific geographic area and where the included second data element stores a time and/or date within the time and/or date range; identify one or more transaction behaviors based on at least a number of transaction data entries included in the identified subset of transaction data entries and data stored in one or more of the plurality of data elements included in each transaction data entry included in the identified subset of transaction data entries; and execute a second query on the first database to identify a parking data correlation where the included one or more correlated transaction behaviors corresponds to the identified one or more transaction behaviors. The transmitting device of the processing server is configured to transmit at least the one or more parking metrics included in the identified parking data correlation in response to the received parking metric request.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for the generation of data correlations between parking metrics and transaction behavior and use thereof in estimating parking metrics in accordance with exemplary embodiments.

FIG. 2 is a block diagram illustrating the processing server of FIG. 1 for the generation and use of data correlations between parking metrics and transaction behavior in accordance with exemplary embodiments.

FIG. 3 is a flow diagram illustrating a process for the generation of data correlations between parking metrics and transaction behavior and use thereof in estimation of parking metrics using the system of FIG. 1 in accordance with exemplary embodiments.

FIG. 4 is a flow chart illustrating an exemplary method for generating data correlations between parking metrics and transaction behavior in accordance with exemplary embodiments.

FIG. 5 is a flow chart illustrating an exemplary method for generating data estimates of parking metrics based on transaction behaviors in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Generation and Use of Data Correlations Between Parking Metrics and Transaction Behaviors

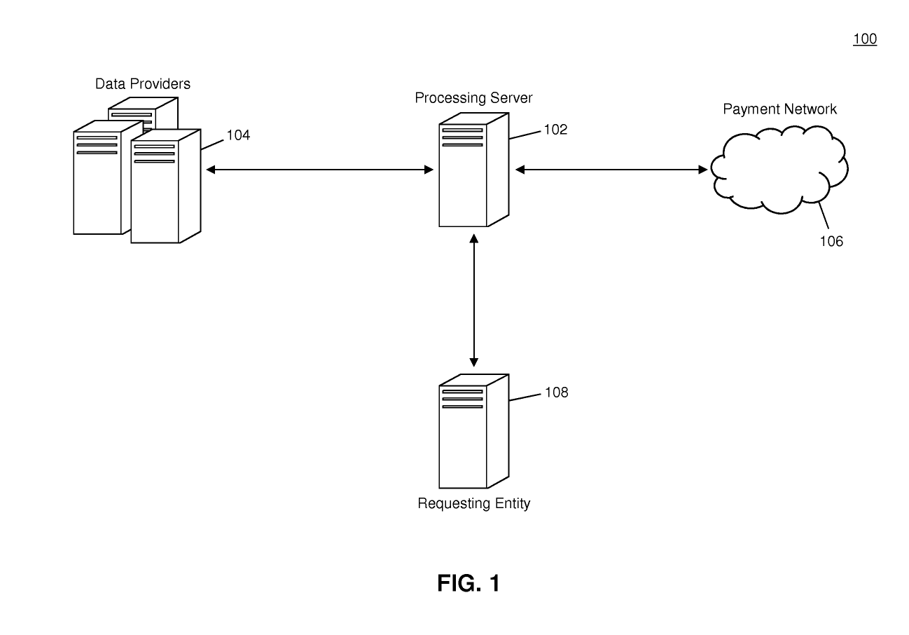

FIG. 1 illustrates a system 100 for the generation of data correlations between parking metrics for a geographic area and transaction behaviors based on transaction data therein, and use thereof in the estimation of parking metrics for a geographic area based on transaction behaviors.

The system 100 may include a processing server 102. The processing server 102, discussed in more detail below, may be configured to generate data correlations between parking metrics and transaction behaviors, including the generation of the transaction behaviors based on payment transaction data, and use of the generated data correlations in the estimation of parking metrics. The processing server 102 may be one or more computing systems specially configured to perform the functions disclosed herein, thereby comprising a special purpose computing system. The processing server 102 may be configured to receive and store parking metrics and parking data for one or more geographic areas, and receive and store transaction data for payment transactions in one or more geographic areas, and use these disparate data sets to generate data correlations between parking metrics and transaction behavior.

In the system 100, parking metrics and other parking data may be provided to the processing server 102 by one or more data providers 104. Data provider 104 may include governmental agencies, parking businesses, research agencies, survey firms, transportation agencies, and other data sources that may be configured to collect parking data and parking metrics to provide to the processing server 102. The data providers 104 may communicate with the processing server 102 via one or more suitable communication networks, which may include the Internet, cellular communication networks, local area networks, radio frequency, etc. Data signals may be superimposed with parking data and parking metrics by computing devices of the data providers 104, which may be electronically transmitted via the communication network to the processing server 102. The processing server 102 may receive the data signals and parse the data superimposed thereon to obtain the parking metrics and other parking data. The processing server 102 may store the data received from the data providers 104 in a data structure, wherein the stored data may be standardized for implementation in the systems and methods described herein.

As discussed in more detail below, the processing server 102 may store the parking metrics as standardized data sets in a database, which may be locally stored in the processing server 102 or stored in an external database and accessed remotely, such as via the same or an alternative communication network using data signals for communication. For example, in some embodiments, parking metrics may be stored in external data storage and accessed using one or more cloud computing techniques that will be apparent to persons having skill in the relevant art.

The data signals received by the processing server 102, from the data providers 104, may comprise data related to one or more entities which may be directly or indirectly associated with parking availability and parking services in one or more particular locations. In some embodiments, the data signals may comprise data related to parking of a geographic location (e.g., data related to parking garages; metered parking spaces; restaurants; entertainment venues; public transportation providers; and other area businesses and/or events that may affect parking availability in a given geographic area). The data signals may comprise geographic location data representative of the geographic location of entities that may affect parking availability or such geographic location data may be obtained subsequent or prior to entity-specific data. The data signals may also comprise additional data related thereto, e.g., location, parking capacity, rates (particularly for parking providing entities, etc.); hours of operation, store/business location capacity, turnover rate (e.g., in regard to restaurants), average amount of time spent by a consumer at location, etc. The data signals may comprise data representative of one-time or multiple-time events (e.g., a concert occurring on a specific data at a specific time in a specific venue). The data signals may comprise location (e.g., station location information, etc.), operating hours, capacity, average capacity for a given day/time/location, etc. for public transportation and other types of transportation means alternative to personal vehicles (e.g., ride share data, etc.).

In embodiments, the processing server 102 may receive information related to an entity in response to an initial action by the processing server 102. In some embodiments, the processing server 102 may execute a process for acquiring additional information related to an entity/parking of an area by, for example, conducting an automated web search or communicating with a database which may store entity-related information (e.g., ticket warehouse; venue websites; restaurant reservations systems; entity-review-related websites and databases, etc.). In some embodiments, the processing server 102 may receive data submitted directly or indirectly from an entity device via a communications network. The data acquired by the processing server 102 may be aggregated and stored in one or several databases, wherein the database may include a plurality of data entries, each associated with one or more parking identifying information and various terms, as described above, that may be associated with the parking identifying information which may have a direct or indirect effect on parking availability in a parking location at a given time. In some instances, multiple data entries identifying parking locations may be grouped (e.g., all parking spaces within a neighborhood block may be assigned a value which collectively identifies the parking spaces within the neighborhood block, etc.) The system 100 may also include a payment network 106. The payment network 106 may be configured to process payment transactions and obtain transaction data associated thereto. Transaction data may include transaction amounts, transaction times and/or dates, geographic locations, merchant data, consumer data, offer data, reward data, loyalty data, product data, etc. As part of the processing of payment transactions, the payment network 106 may receive transaction messages. Transaction messages may be specially formatted data sets that are formatted based on one or more standards, such as the International Organization for Standardization's ISO 8583 standard. Transaction messages may include a plurality of data elements, each data element being configured to store data as set forth in the associated standard(s), such as data elements configured to store primary account numbers, merchant category codes, merchant identifiers, geographic locations, transaction amounts, transaction times, etc. Transaction messages may be communicated using specially configured infrastructure that utilizes specialized communication protocols, known to persons having skill in the art as “payment rails.” The payment rails may be specialized infrastructure specially configured for the secure transmission of transaction messages and other sensitive financial information, and may be access only via specialized computing systems and not by general purpose computers lacking the specialized programming required for communications with the payment rails infrastructure.

The processing server 102 may be configured to obtain transaction data from the payment network 106. In some embodiments, the payment network 106 may provide the processing server 102 with transaction messages for a plurality of payment transactions. In such embodiments, the processing server 102 may be specially configured to communicate with the payment network 106 using the payment rails and be configured to receive transaction messages, formatted based on the associated standards, using the specialized infrastructure and protocols of the payment rails. In some instances, the processing server 102 may electronically transmit a data signal to the payment network 106 via the payment rails or an alternative communication network requesting the transaction messages. In other instances, the payment network 106 may periodically transmit transaction messages to the processing server 102, where the period may be established by the processing server, payment network 106, or suitable criteria, such as based on the needs of the processing server 102 in providing the data. The processing server 102 may be configured to parse the received transaction messages to obtain the data stored in the data elements included therein. In other embodiments, the payment network 106 may superimpose data signals with transaction data for payment transactions, which may be transmitted to the processing server 102 using other suitable communication networks, such as the Internet or cellular communication networks. In some instances, transaction data transmitted to the processing server 102 for use in performing the functions discussed herein may have some data removed. For example, the data stored in some data elements may be removed from the transaction messages prior to transmission or superimposition, such as account numbers, consumer data, or other data that may not be used by the processing server 102 or may be removed to protect consumer privacy or security.

The processing server 102 may be configured to generate data correlations between parking metrics and transaction behaviors. For a given geographic area and time and/or date range, the processing server 102 may execute queries on databases storing transaction data and parking metrics and identify transaction data and parking metrics for the geographic area and the time and/or date range. The processing server 102 may identify transaction behaviors for the geographic area and time and/or date range based on the identified transaction data. Transaction behaviors may include, for example, transaction frequency, parking purchase frequency, transportation purchase frequency, number of transaction, transaction merchant types, average ticket amount, propensity to spend on parking, parking and transportation spend ratios, etc. The transaction behaviors may be based on the transaction data for one or more payment transactions conducted in the geographic area during the time and/or date range. For instance, to identify parking purchase frequency, the processing server 102 may identify transaction data for payment transactions where a merchant category code indicating a parking vendor is included, which may signify a transaction for the purchase of parking, and may identify the frequency of such transactions among all payment transactions in the geographic area during the time and/or date range. The processing server 102 may be configured to aggregate and/or tag events that may be related to a geographic areas' parking capacity, either directly or indirectly. For instance, the processing server 102 may tag, or otherwise demarcate, directly related events such as payments at parking garages based upon geography/time or payments at meter parking based upon geography/time, etc. The processing server 102, may tag, for example, indirectly related events such as purchases for tickets of a particular venue (remotely or on-location purchases), dinner-related purchases of a particular geographic area (e.g., transactions conducted at all restaurants on block A, etc.); transactions conducted at a mall or other group of, or individual, business location; transactions conducted at a public transportation location or related to such a location; etc. The processing server 102 may be configured to assign values to various events, wherein the values may represent a significance score based upon one or more characteristics of the events (e.g., proximity to area of concern, direct/indirect nature of event, etc.)

The processing server 102 may then identify data correlations between the transaction behaviors for the geographic area and parking metrics over several time and/or date ranges. For example, the processing server 102 may identify that when the parking purchase frequency is at a specific level, the available parking capacity is at a specific level. In another example, the processing server 102 may identify a data correlation between parking cost and amount of spending or average ticket price for parking-related transactions. In some instances, data correlations may be identified for a specific geographic area. In some cases, the processing server 102 may be configured to compare data correlations across multiple geographic areas. For instance, the processing server 102 may identify that the data correlations are the same for geographic areas of different sizes or demographics if the transaction behavior is the same, or may identify that two different areas with the same transaction behavior may have different data correlations, such as due to extraneous factors like the availability of public transportation. In some instances, such identifications may be used in the estimation of parking metrics, as discussed below.

The processing server 102 may group data correlations into location-associated segments automatically from time-to-time or in response to the receipt of an instruction for grouping and store such correlated data in one or several databases. The processing server 102 may update the data correlations at predetermined time intervals (e.g., once an hour, once a day, once a minute, every 3 minutes, etc.) based upon newly received data that may affect the location associated segments. The processing server 102 may update the data correlations each time newly received data affecting the location associated segments is received (e.g., transaction data associated with an area entity, etc.).

In embodiments, the processing server 102 may receive information related to parking in a location based upon user survey data. For instance, a survey may be provided to a mobile device of a user, and displayed thereby to the user for user-input. The user may be prompted to provide responses to a series of questions related to parking (e.g., “did you pay for parking?” etc.). The survey notification may be provided to the consumer automatically, e.g., based upon a detection of a geographic location of the mobile device, in response to an electronic transaction associated with the mobile device (e.g., the mobile device is associated with a card funding an electronic transaction received from a particular point of sale device, etc.). Various other methods and systems by which a survey may be provided and received by the processing server 102 may also be implemented to receive parking-related information and store the information as useful data. In some embodiments, the processing server 102 may receive location related information (e.g. via GPS of a mobile device or vehicle, etc.). The location related information may be collected, e.g., by a mobile application running on a mobile device of a driver, from a vehicle system associated with the driver, etc. The location related information may be analyzed to determine whether the device from which the location information originated is operating in a manner which indicates parking is unavailable. For instance, the location-related data may be analyzed to determine if a device is repeatedly circling an area (such as a neighborhood block or groups of blocks, if a device has attempted entry into a parking structure, entered/exited a structure within a predetermined period of time, etc.). The processing server 102 may store the information for use in analytics performed on the data to determine parking availability or formulate a prediction of parking availability in a specified area.

The system 100 may also include a requesting entity 108. The requesting entity 108 may be an entity requesting data correlations between parking metrics and transaction data and/or the estimation of parking metrics based on transaction data. The requesting entity 108 may be, for instance, a data provider 104, the payment network 106, or other suitable entity, such as a governmental agency researching the parking situation in a municipality, a transportation company evaluating transportation routes and fares, a parking company researching for parking fees and the expansion or building of parking structures. The requesting entity 108 may be a device operated by any of such entities. In some instances, the estimation of parking metrics may be made available to a person looking to park, such as via an application program of a mobile communication device, where the person may view the parking capacity for a geographic area estimated by the processing server 102 prior to visiting the area to establish a plan for how to arrive to the area and, if necessary, where to go for parking.

The requesting entity 108 may electronically transmit a data signal to the processing server 102 that is superimposed with at least a geographic area and a time and/or date range for which parking metrics are requested. The processing server 102 may parse the data signal for the geographic area and time and/or date range, and identify transaction data for payment transactions processed in the geographic area during the time and/or date ranged based on the data included therein. The processing server 102 may generate transaction behaviors for the geographic area and time and/or date range using the identified transaction data. Once the transaction behaviors are generated, the processing server 102 may execute a query on a database to identify data correlations between the generated transaction behaviors and parking metrics. The correlated parking metrics may then be used to estimate parking metrics for the geographic area at the time and/or date. The processing server 102 may generate a data signal superimposed with the estimated parking metrics, which may be electronically transmitted to the requesting entity 108.

In some embodiments, the transaction data identified by the processing server 102 for use in the estimation of the parking metrics may be for a similar time and/or day, but at a different time and/or date, and/or for similar geographic areas at the same or a similar time and/or day. For example, the requesting entity 108 may be requesting estimated parking capacity for a Saturday at 8:00 PM. In such an instance, the processing server 102 may identify transaction behavior for the geographic area at previous Saturdays around 8:00 PM, or for Saturdays at 8:00 PM during the same time of year in the same or similar geographic areas, or for weekends at 8:00 PM, or for evenings at 8:00 PM having the same weather (e.g., based on data available via data providers 104), etc. In such instances, the transaction data may be used as an estimate of the transaction data for the time and/or date requested, such as in instances where the requesting entity 108 may request an estimate of parking capacity at the present time, when transaction data for the present time may be unavailable.

By generation transaction behaviors at various time and/or date ranges for geographic areas and correlating the behaviors with parking metrics, the processing server 102 may be configured to provide accurate estimations of parking capacity and parking metrics without the need to technologically update parking structures and systems and in a way that is more efficient and more effective than traditional methods for identifying parking capacity. By using transaction behavior, the processing server 102 may identify parking metrics for a geographic area where there is currently no method available for evaluating parking metrics. As a result, the system 100 discussed herein may provide for a significant technological improvement to the generation of data correlations between transaction behaviors and parking metrics and use thereof in the estimation of parking metrics for a geographic area.

### Processing Server

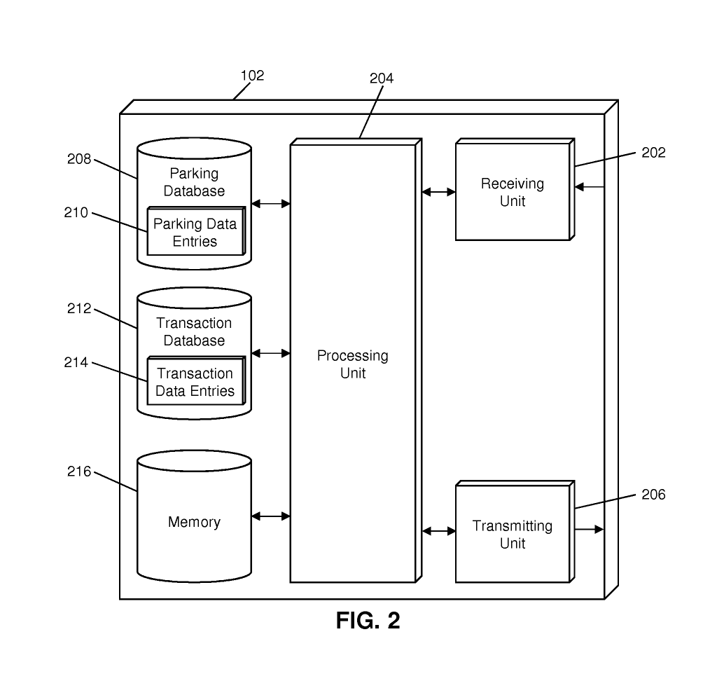

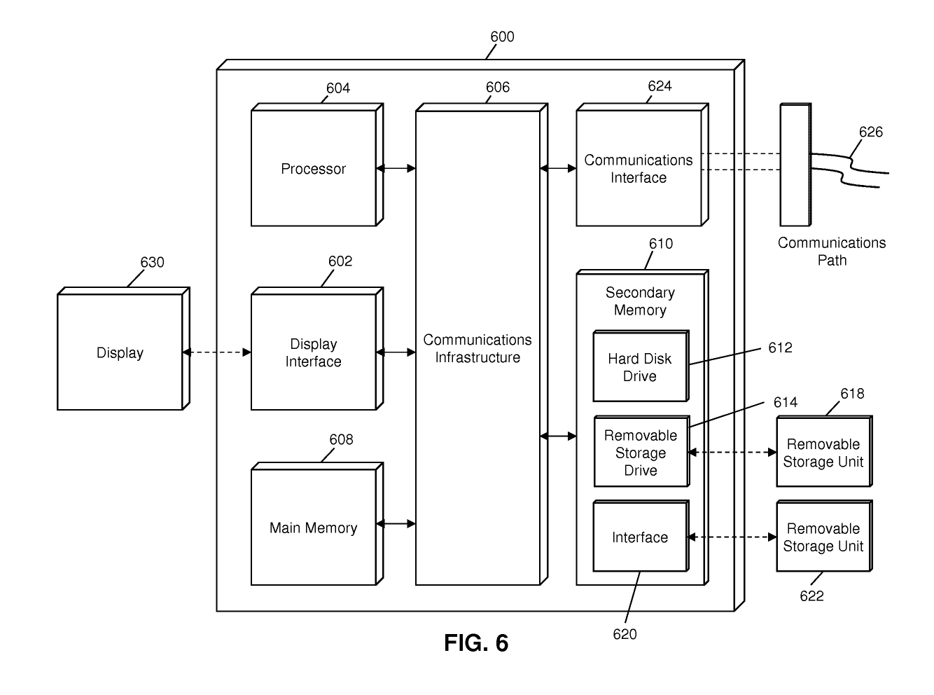

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 600 illustrated in FIG. 6 and discussed in more detail below may be a suitable configuration of the processing server 102.

The processing server 102 may include a receiving unit 202. The receiving unit 202 may be configured to receive data over one or more networks via one or more network protocols. In some embodiments, the receiving unit 202 may be configured to receive data over the payment rails, such as using specially configured infrastructure associated with payment networks 106 for the transmission of transaction messages that include sensitive financial data and information. In some instances, the receiving unit 202 may also be configured to receive data from data providers 104 and requesting entities 108, and other entities via alternative networks, such as the Internet. In some embodiments, the receiving unit 202 may be comprised of multiple units, such as different receiving units for receiving data over different networks, such as a first receiving unit for receiving data over payment rails and a second receiving unit for receiving data over the Internet. The receiving unit 202 may receive electronically data signals that are transmitted, where data may be superimposed on the data signal and decoded, parsed, read, or otherwise obtained via receipt of the data signal by the receiving unit 202. In some instances, the receiving unit 202 may include a parsing module for parsing the received data signal to obtain the data superimposed thereon.

The receiving unit 202 may be configured to receive data signals electronically transmitted by the data providers 104 superimposed with data comprising parking metrics, which may include parking metrics for a plurality of date and/or time ranges and geographic areas. The receiving unit 202 may also be configured to receive data signals electronically transmitted by the payment network 106 superimposed with data comprising transaction data for a plurality of payment transactions. In some embodiments, the transaction data may be comprised in transaction messages, which may be electronically transmitted by the payment network 106 and received by the receiving unit 202 using the payment rails. Transaction data received by the receiving unit 202 may be for a plurality of payment transactions and include at least a time and/or date and geographic area for the payment transaction, as well as additional data suitable for use in performing the functions discussed herein, such as merchant category data.

The processing server 102 may also include a processing unit 204. The processing unit 204 may be configured to perform the functions of the processing server 102 discussed herein as will be apparent to persons having skill in the relevant art. In some embodiments, the processing unit 204 may include and/or be comprised of a plurality of engines and/or modules specially configured to perform one or more functions of the processing unit 204. For example, the processing unit 204 may include a querying module configured to query databases included in the processing server 102 to identify information stored therein. In some instances, the processing unit 204 may include a parsing module or engine configured to parse data from data signals electronically received by the receiving unit 202, an encryption module or engine configured to decrypt received data or data signals or to encrypt data or data signals received or transmitted by the processing server 102, and any other modules suitable for performing the functions discussed herein.

The processing server 102 may also include a parking database 208. The parking database 208 may be configured to store a plurality of parking data entries 210 using a suitable data storage method and schema. Each parking data entry 210 may be a standardized data set configured to store at least a geographic area, a time and/or date, and one or more parking metrics. The one or more parking metrics may be parking metrics for the associated geographic area and time and/or date and may include, for instance, parking capacity, parking availability, parking search time, and parking cost. The geographic area may be represented using any suitable type of geographic representation, such as zip codes, postal codes, street addresses, latitude and longitude, municipalities, etc.

The processing server 102 may also include a transaction database 212. The transaction database 212 may be configured to store a plurality of transaction data entries 214 using a suitable data storage method and schema. Each transaction data entry 214 may include data related to a payment transaction including at least a transaction time and/or date and a geographic location. In some instances, a transaction data entry 214 may further include a merchant category code or additional transaction data, such as merchant data, point of sale data, consumer data, product data, transaction amount, etc. In some embodiments, each transaction data entry 214 may be or comprise a transaction message formatted pursuant to one or more standards, where the data included therein may be stored in data elements configured to store data as set forth in the one or more standards. For example, the transaction data entries 214 may be transaction messages having a first data element configured to store a geographic location and a second data element configured to store a time and/or date.

The processing unit 204 (e.g., a querying module or engine included therein) may be configured to execute queries on the parking database 208 and transaction database 212 to identify data included therein. For instance, the processing unit 204 may execute a first query on the parking database 208 to identify a parking data entry 210 where the included geographic area and time and/or date correspond to a specific geographic area and time and/or date range (e.g., as parsed from a request from the requesting entity 108 received by the receiving unit 202) and may execute a second query on the transaction database 212 to identify transaction data entries 214 where the included geographic area and time and/or date correspond to the specific geographic area and time and/or date range. The processing unit 204 (e.g., an analytic module or engine included therein) may be further configured to generate transaction behaviors for the identified transaction data entries 214 based on the transaction data included therein, such as transaction frequency, parking purchase frequency, transportation purchase frequency, number of transaction, transaction merchant types, etc. As used herein, the term “module” denotes the software and/or hardware configured to receive a specified input, perform a process thereon, and execute an output based upon the process performed by the module.

The processing unit 204 (e.g., a correlation module or engine included therein) may also be configured to generate data correlations between parking metrics and transaction behaviors based on the parking metrics and transaction behaviors for one or more geographic areas at a plurality of date and/or time ranges. The processing unit 204 (e.g., an estimation module or engine included therein) may be further configured to estimate parking metrics for a geographic area at a date and/or time based on transaction behaviors generated for the same or a similar date and/or time.

The processing unit 204 (e.g., via an analyzing module) may implement standard analytical methods to determine factors predictive of parking capacity (e.g., regression, correlation, decision trees, clustering, etc.). The processing unit 204 receive as input one or more of parking metrics data, transaction data, user device data (e.g., indicative of location of user/car, indicative of time device left user home to time of a user transaction (which may be associated via the transaction database, etc.). The analyzing module may output conclusions indicative of parking situations of given areas. The conclusion may be output and transmitted to a user device, upon which the conclusion may be displayed. The conclusion may be displayed as text or an illustration (e.g., as a chart, map, etc.). The conclusion may be superimposed upon, e.g., a map, wherein the appearance of the map may be altered (e.g., if parking is unlikely to be available, a map may change color, a symbol may be imposed on the map, etc.).

The processing server 102 may further include a transmitting unit 206. The transmitting unit 206 may be configured to transmit data over one or more networks via one or more network protocols. In some embodiments, the transmitting unit 206 may be configured to transmit data over the payment rails, such as using specially configured infrastructure associated with payment networks 106 for the transmission of transaction messages that include sensitive financial data and information, such as identified payment credentials. In some instances, the transmitting unit 206 may be configured to transmit data to data providers 104 and requesting entities 108, and other entities via alternative networks, such as the Internet. In some embodiments, the transmitting unit 206 may be comprised of multiple units, such as different transmitting units for transmitting data over different networks, such as a first transmitting unit for transmitting data over the payment rails and a second transmitting unit for transmitting data over the Internet. The transmitting unit 206 may electronically transmit data signals that have data superimposed that may be parsed by a receiving computing device. In some instances, the transmitting unit 206 may include one or more modules for superimposing, encoding, or otherwise formatting data into data signals suitable for transmission.

The transmitting unit 206 may be configured to transmit data requests to the data providers 104 and payment networks 106, such as to request parking data or transaction data for use in performing the functions discussed herein. In some embodiments, data requests may be transmitted separately from requests for data received by the receiving unit 202. In other embodiments, the transmitting unit 206 may transmit data requests for data for use in estimating parking metrics based on a received data request, such as for requesting transaction data for payment transaction at a specific date and/or time for which estimated parking metrics are requested. The transmitting unit 206 may also be configured to electronically transmit data signals to the requesting entity 108 superimposed with estimated parking metrics, such as in response to a request for parking metrics electronically transmitted by the requesting entity 108 and received by the receiving unit 202.

The processing server 102 may also include a memory 216. The memory 216 may be configured to store data for use by the processing server 102 in performing the functions discussed herein. The memory 216 may be configured to store data using suitable data formatting methods and schema and may be any suitable type of memory, such as read-only memory, random access memory, etc. The memory 216 may include, for example, encryption keys and algorithms, communication protocols and standards, data formatting standards and protocols, program code for application programs, rules and algorithms for generating transaction behaviors, and other data that may be suitable for use by the processing server 102 in the performance of the functions disclosed herein as will be apparent to persons having skill in the relevant art.

In an example embodiment, a user device storing an application configured to communicate with the processing server 102 may initiate a communication with the processing server 102. For instance, a user may input a selection of an area (e.g., by touching a display of an area on a map displayed by the application, by inputting or selecting from a list a neighborhood, street, block range, etc.). The user device may transmit the user selection to the processing server 102. The processing server may identify, in one or more databases, parking-related data and/or analytical results of the processing server 102 for the area identified by the user selection. The processing server may cause the parking-related analysis/data to be transmitted to the user device for display thereon. The user may view the result provided by the processing server visually, via the application, (e.g., as text “search time for parking is 15 minutes”, an icon superimposed on a map displayed by the device, etc.).

### Process for Generating Data Correlations Between Parking Metrics and Transaction Behaviors

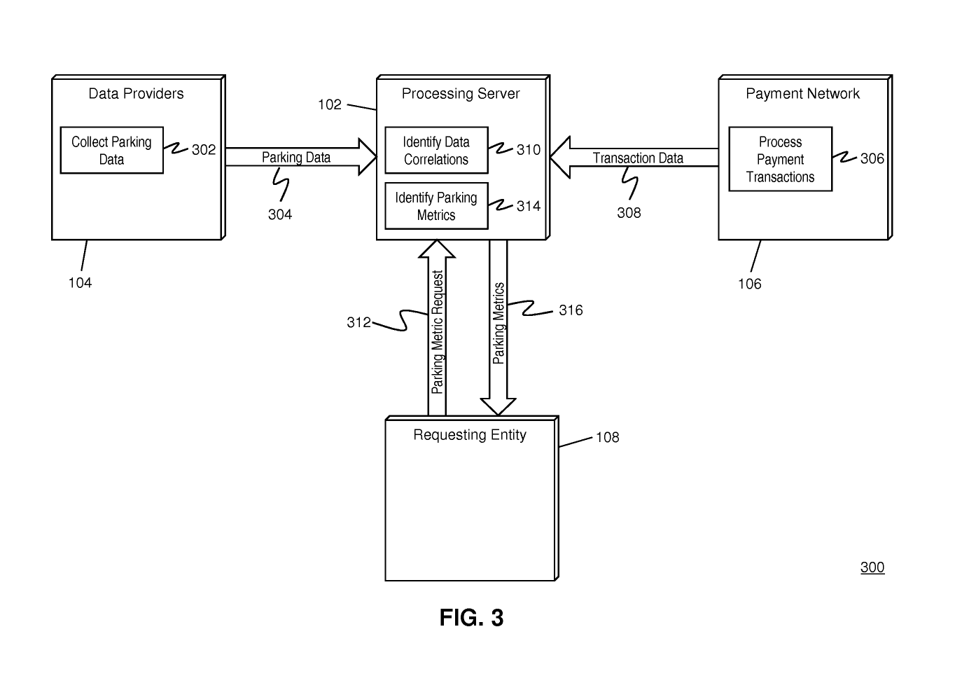

FIG. 3 illustrates a process 300 for the generation of data correlations between parking metrics and transaction behaviors in the system 100 and use thereof in the estimation of parking metrics for geographic area at a time and/or date based on transaction behaviors.

In step 302, the data providers 104 may collect parking data. The parking data may include parking metrics for one or more geographic areas at a plurality of times and/or dates. Parking data may be collected via surveys, crowdsourcing, physical examination, data analysis, and any other method suitable for the collection of data associated with parking in a geographic area. In some instances, parking data may include transportation data, such as related to public transportation and/or non-public forms of transportation, such as private vehicle data. In step 304, the data providers 104 may electronically transmit a data signal superimposed with the collected parking data to the processing server 102. The receiving unit 202 of the processing server 102 may receive the data signal and the receiving unit 202 or processing unit 204 of the processing server 102 may parse the received data signal to obtain the parking data superimposed thereon, which may be stored in the parking database 208.

In step 306, the payment network 106 may process a plurality of payment transactions using traditional methods and systems that will be apparent to persons having skill in the relevant art. As part of the processing of payment transactions, the payment network 106 may receive and store transaction data for the payment transactions. In some embodiments, the transaction data may be stored in specially formatted transaction messages, in data elements included therein configured to store data as set forth in associated standards. In step 308, the payment network 106 may transmit the transaction data to the processing server 102. In some embodiments, the transaction data may be superimposed on data signals electronically transmitted by the payment network 106 using standard communication networks. In other embodiments, the transaction messages containing the transaction data may be transmitted to the processing server 102 using the payment rails, such as by electronically transmitting the transaction messages through the specialized infrastructure associated with the payment network 106 for communication therewith. In each embodiment, the receiving unit 202 of the processing server 102 may receive the transaction data, which may be stored in the transaction database 212.

In step 310, the processing unit 204 of the processing server 102 may identify data correlations between the parking data and transaction behaviors. Step 310 may include the execution of queries by the processing unit 204 of the parking database 208 and transaction database 212 to identify parking and transaction data for a geographic area at a plurality of date and/or time ranges, the generation of transaction behaviors for the geographic area at each of the plurality of date and/or time ranges based on the associated transaction data, and the generation of data correlations for the geographic area between the parking metrics and transaction behaviors at the various time and/or date ranges.

In step 312, the requesting entity 108 may electronically transmit a data signal to the processing server 102 superimposed with a parking metric request. The parking metric request may include at least a geographic area and a time and/or date for which parking metrics are requested. In some instances, the parking metric request may include one or more parking metrics that are specifically requested, such as specifying that parking availability for the geographic area at the time and/or date is requested. The receiving unit 202 of the processing server 102 may receive the data signal, which may be parsed to obtain the parking metric request and data included therein.

In step 314, the processing unit 204 of the processing server 102 may identify an estimate of parking metrics in response to the received request. The estimation may include the execution of a query on the transaction database 212 to identify transaction data entries 214 for the geographic area at the specified time and/or date or a similar time and/or date, the generation of transaction behaviors using the identified transaction data entries 214, and the identification of data correlations that include the generated transaction behaviors. The parking metrics that are correlated with the generated transaction behaviors may thereby be identified by the processing unit 204 as estimates for parking metrics for the specified geographic area and time and/or date included in the parking metric request. In step 316, the transmitting unit 206 of the processing server 102 may electronically transmit a data signal superimposed with the identified parking metrics to the requesting entity 108.

In an example, the requesting entity 108 may be an individual utilizing a mobile device, such as a smart phone, to request an estimation of parking capacity near a geographic location they plan to visit. For instance, the individual may have a dinner reservation and is deciding between parking on the street near the restaurant, parking in a nearby parking garage, or taking public transportation. The parking metric request may include a request for parking metrics at the geographic location (e.g., near the restaurant) for the date and time of the reservation. The requested parking metrics may include, for instance, estimated parking capacity and estimated time to locate a parking space in the geographic area near the location at that date and time. The processing server 102 may identify and return the requested parking metrics, which the individual may then use to make a determination as to how to get to their destination. For instance, the processing server 102 may estimate that street parking will be near 100% capacity, while the parking garage will have a 70% capacity with a low time to find a parking space. In such an instance, the individual may decide to drive, and to head straight for the parking garage rather than attempt to find street parking.

### Exemplary Method for Generating Data Correlations Between Parking Metrics and Transaction Behavior

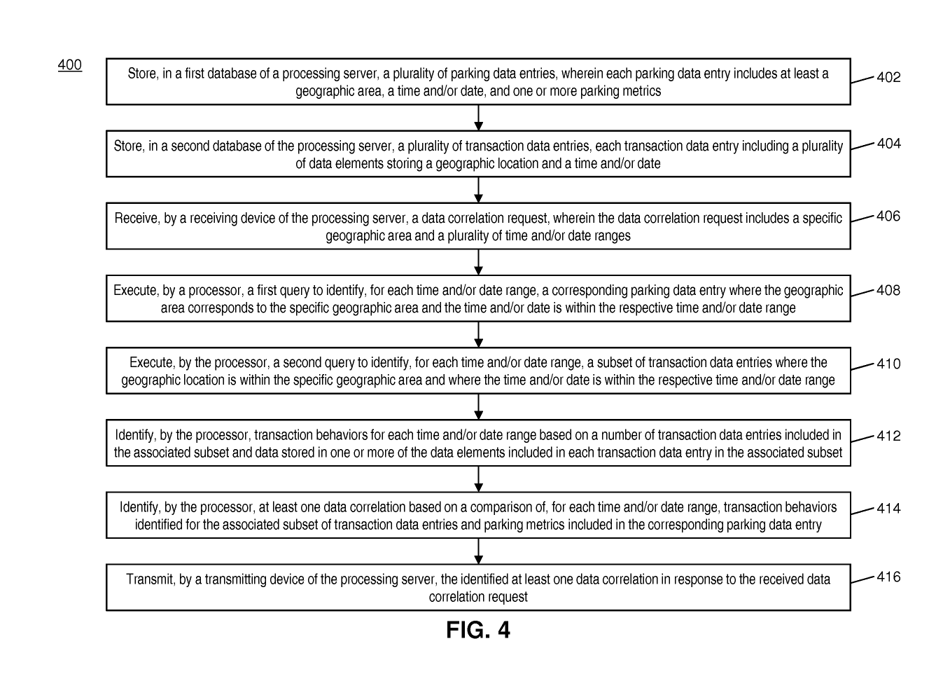

FIG. 4 illustrates a method 400 for the generation of data correlations between parking metrics for a geographic area and transaction behavior based on payment transactions in the geographic area.

In step 402, a plurality of parking data entries (e.g., parking data entries 210) may be stored in a first database (e.g., parking database 208) of a processing server (e.g., the processing server 102), wherein each parking data entry includes at least a geographic area, a time and/or date, and one or more parking metrics. In step 404, a plurality of transaction data entries (e.g., transaction data entries 214) may be stored in a second database (e.g., transaction database 212) of the processing server, wherein each transaction data entry includes a plurality of data elements storing a geographic location and a time and/or date.

In step 406, a data correlation request may be received by a receiving device (e.g., the receiving unit 202) of the processing server, wherein the data correlation request includes a specific geographic area and a plurality of date and/or time ranges. In step 408, a first query may be executed by a processor (e.g., the processing unit 204) of the processing server on the first database to identify, for each time and/or date range, a corresponding parking data entry where the geographic area corresponds to the specific geographic area and the time and/or date is within the respective time and/or date range.

In step 410, a second query may be executed by the processor of the processing server on the second database to identify, for each time and/or date range, a subset of transaction data entries where the geographic location stored in the first data element is within the specific geographic area and where the time and/or date stored in the included second data element is within the respective time and/or date range. In step 412, transaction behaviors for each time and/or date range may be identified by the processor based on a number of transaction data entries included in the associated subset and data stored in one or more of the data elements included in each transaction data entry in the associated subset.

In step 414, at least one data correlation may be identified by the processor of the processing server between transaction behaviors and parking metrics based on a comparison of, for each time and/or date range of the plurality of time and/or date ranges, the one or more transaction behaviors identified for the associated subset of transaction data entries and the one or more parking metrics included in the corresponding parking data entry. In step 416, a transmitting device (e.g., the transmitting unit 206) of the processing server may transmit the identified at least one data correlation in response to the received data correlation request.

In one embodiment, each transaction data entry may further include a third data element configured to store a merchant category identifier, and the one or more transaction behaviors may be further based on data stored in the third data element in each transaction data entry included in the associated subset of transaction data entries. In a further embodiment, the merchant category identifier may be indicative of at least one of: a parking merchant, a transportation merchant, and a miscellaneous merchant. In some embodiments, the one or more parking metrics may include at least one of: parking availability, parking search time, and parking cost. In one embodiment, the one or more transaction behaviors may include at least one of: transaction frequency, parking purchase frequency, transportation purchase frequency, number of transactions, and transaction merchant types.

### Exemplary Method for Generating Data Estimates of Parking Metrics Based on Transaction Behaviors

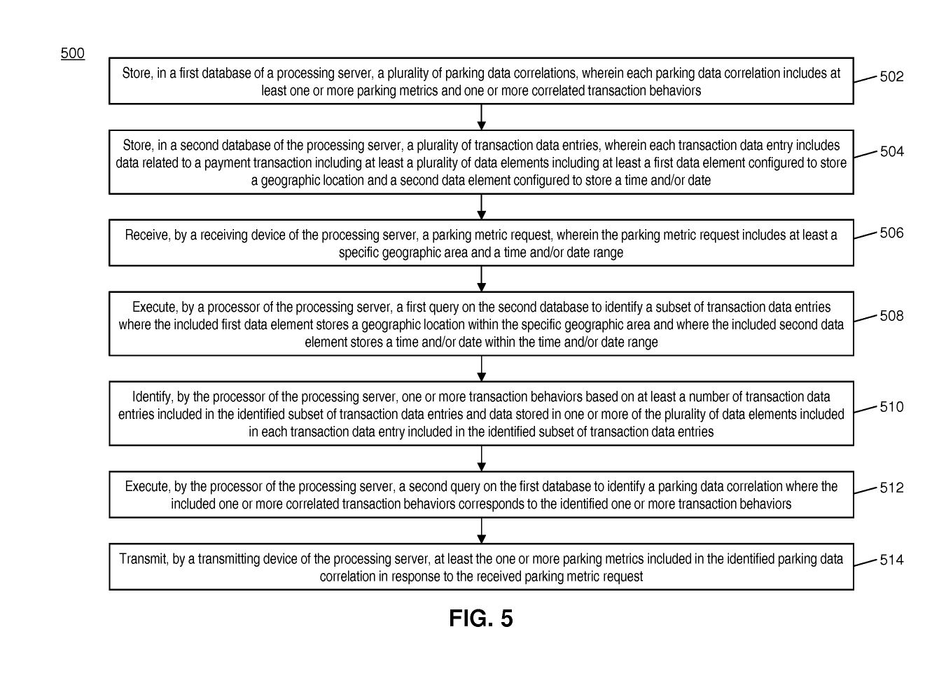

FIG. 5 illustrates a method 500 for the generation of data estimates of parking metrics for a geographic area at a time and/or date based on transaction behaviors in the geographic area for the time and/or date.

In step 502, a plurality of parking data correlations may be stored in a first database (e.g., the memory 216) of a processing server (e.g., the processing server 102), wherein each parking data correlation includes at least one or more parking metrics and one or more correlated transaction behaviors. In step 504, a plurality of transaction data entries (e.g., the transaction data entries 214) may be stored in a second database (e.g., the transaction database 212) of the processing server, wherein each transaction data entry includes data related to a payment transaction including at least a plurality of data elements including at least a first data element configured to store a geographic location and a second data element configured to store a time and/or date.

In step 506, a receiving device (e.g., the receiving unit 202) of the processing server may receive a parking metric request, wherein the parking metric request includes at least a specific geographic area and a time and/or date range. In step 508, a first query may be executed by a processor (e.g., the processing unit 204) of the processing server on the second database to identify a subset of transaction data entries where the included first data element stores a geographic location within the specific geographic area and where the included second data element stores a time and/or date within the time and/or date range.

In step 510, one or more transaction behaviors may be identified by the processor of the processing server based on at least a number of transaction data entries included in the identified subset of transaction data entries and data stored in one or more of the plurality of data elements included in each transaction data entry included in the identified subset of transaction data entries. In step 512, a second query may be executed by the processor of the processing server on the first database to identify a parking data correlation where the included one or more correlated transaction behaviors corresponds to the identified one or more transaction behaviors. In step 514, at least the one or more parking metrics included in the identified parking data correlation may be transmitted by a transmitting device (e.g., the transmitting unit 206) of the processing server in response to the received parking metric request.

In one embodiment, each transaction data entry may further include a third data element configured to store a merchant category identifier, and the one or more transaction behaviors may be further based on data stored in the third data element in each transaction data entry included in the associated subset of transaction data entries. In a further embodiment, the merchant category identifier may be indicative of at least one of: a parking merchant, a transportation merchant, and a miscellaneous merchant. In some embodiments, the one or more parking metrics may include at least one of: parking availability, parking search time, and parking cost. In one embodiment, the one or more transaction behaviors may include at least one of: transaction frequency, parking purchase frequency, transportation purchase frequency, number of transactions, and transaction merchant types.

### Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

The processor device 604 may comprise one or more modules or engines configured to perform the functions of the computer system 600. Each of the modules or engines may be implemented using hardware and, in some instances, may also utilize software, such as corresponding to program code and/or programs stored in the main memory 608 or secondary memory 610. In such instances, program code may be compiled by the processor device 604 (e.g., by a compiling module or engine) prior to execution by the hardware of the computer system 600. For example, the program code may be source code written in a programming language that is translated into a lower level language, such as assembly language or machine code, for execution by the processor device 604 and/or any additional hardware components of the computer system 600. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, systems and methods for generating data correlations between parking metrics and transaction behaviors and uses thereof. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for generating data correlations between parking metrics and transaction behavior, comprising:
storing, in a first database of a processing server, a plurality of parking data entries, wherein each parking data entry includes at least a geographic area, a time and/or date, and one or more parking metrics;
storing, in a second database of the processing server, a plurality of transaction data entries, wherein each transaction data entry includes data related to a payment transaction including at least a plurality of data elements including at least a first data element configured to store a geographic location and a second data element configured to store a time and/or date;
receiving, by a receiving device of the processing server, a data correlation request, wherein the data correlation request includes a specific geographic area and a plurality of time and/or date ranges;
executing, by a processor of the processing server, a first query on the first database to identify, for each time and/or date range of the plurality of time and/or date ranges, a corresponding parking data entry where the included geographic area corresponds to the specific geographic area and where the included time and/or date is within the respective time and/or date range;
executing, by the processor of the processing server, a second query on the second database to identify, for each time and/or date range of the plurality of time and/or date ranges, a subset of transaction data entries where the geographic location stored in the included first data element is within the specific geographic area and where the time and/or date stored in the included second data element is within the respective time and/or date range;
identifying, by the processor of the processing server, one or more transaction behaviors for each time and/or date range of the plurality of time and/or date ranges based on at least a number of transaction data entries included in the associated subset of transaction data entries and data stored in one or more of the plurality of data elements included in each transaction data entry included in the associated subset of transaction data entries;
identifying, by the processor of the processing server, at least one data correlation between transaction behaviors and parking metrics based on a comparison of, for each time and/or date range of the plurality of time and/or date ranges, the one or more transaction behaviors identified for the associated subset of transaction data entries and the one or more parking metrics included in the corresponding parking data entry; and
transmitting, by a transmitting device of the processing server, the identified at least one data correlation in response to the received data correlation request.

2. The method of claim 1, wherein
each transaction data entry further includes a third data element configured to store a merchant category identifier, and
the one or more transaction behaviors are further based on data stored in the third data element in each transaction data entry included in the associated subset of transaction data entries.

3. The method of claim 2, wherein the merchant category identifier is indicative of at least one of: a parking merchant, a transportation merchant, and a miscellaneous merchant.

4. The method of claim 1, wherein the one or more parking metrics includes at least one of: parking availability, parking search time, and parking cost.

5. The method of claim 1, wherein the one or more transaction behaviors includes at least one of: transaction frequency, parking purchase frequency, transportation purchase frequency, number of transactions, and transaction merchant types.

6. A method for generating data estimates of parking metrics based on transaction behaviors, comprising:
storing, in a first database of a processing server, a plurality of parking data correlations, wherein each parking data correlation includes at least one or more parking metrics and one or more correlated transaction behaviors;
storing, in a second database of the processing server, a plurality of transaction data entries, wherein each transaction data entry includes data related to a payment transaction including at least a plurality of data elements including at least a first data element configured to store a geographic location and a second data element configured to store a time and/or date;
receiving, by a receiving device of the processing server, a parking metric request, wherein the parking metric request includes at least a specific geographic area and a time and/or date range;
executing, by a processor of the processing server, a first query on the second database to identify a subset of transaction data entries where the included first data element stores a geographic location within the specific geographic area and where the included second data element stores a time and/or date within the time and/or date range;
identifying, by the processor of the processing server, one or more transaction behaviors based on at least a number of transaction data entries included in the identified subset of transaction data entries and data stored in one or more of the plurality of data elements included in each transaction data entry included in the identified subset of transaction data entries;
executing, by the processor of the processing server, a second query on the first database to identify a parking data correlation where the included one or more correlated transaction behaviors corresponds to the identified one or more transaction behaviors; and
transmitting, by a transmitting device of the processing server, at least the one or more parking metrics included in the identified parking data correlation in response to the received parking metric request.

7. The method of claim 6, wherein
each transaction data entry further includes a third data element configured to store a merchant category identifier, and
the one or more transaction behaviors are further based on data stored in the third data element in each transaction data entry included in the associated subset of transaction data entries.

8. The method of claim 7, wherein the merchant category identifier is indicative of at least one of: a parking merchant, a transportation merchant, and a miscellaneous merchant.

9. The method of claim 6, wherein the one or more parking metrics includes at least one of: parking availability, parking search time, and parking cost.

10. The method of claim 6, wherein the one or more transaction behaviors includes at least one of: transaction frequency, parking purchase frequency, transportation purchase frequency, number of transactions, and transaction merchant types.

11. A system for generating data correlations between parking metrics and transaction behavior, comprising:
a first database of a processing server configured to store a plurality of parking data entries, wherein each parking data entry includes at least a geographic area, a time and/or date, and one or more parking metrics;
a second database of the processing server configured to store a plurality of transaction data entries, wherein each transaction data entry includes data related to a payment transaction including at least a plurality of data elements including at least a first data element configured to store a geographic location and a second data element configured to store a time and/or date;
a receiving device of the processing server configured to receive a data correlation request, wherein the data correlation request includes a specific geographic area and a plurality of time and/or date ranges;
a processor of the processing server configured to
execute a first query on the first database to identify, for each time and/or date range of the plurality of time and/or date ranges, a corresponding parking data entry where the included geographic area corresponds to the specific geographic area and where the included time and/or date is within the respective time and/or date range,
execute a second query on the second database to identify, for each time and/or date range of the plurality of time and/or date ranges, a subset of transaction data entries where the geographic location stored in the included first data element is within the specific geographic area and where the time and/or date stored in the included second data element is within the respective time and/or date range,
identify one or more transaction behaviors for each time and/or date range of the plurality of time and/or date ranges based on at least a number of transaction data entries included in the associated subset of transaction data entries and data stored in one or more of the plurality of data elements included in each transaction data entry included in the associated subset of transaction data entries, and
identify at least one data correlation between transaction behaviors and parking metrics based on a comparison of, for each time and/or date range of the plurality of time and/or date ranges, the one or more transaction behaviors identified for the associated subset of transaction data entries and the one or more parking metrics included in the corresponding parking data entry; and
a transmitting device of the processing server configured to transmit the identified at least one data correlation in response to the received data correlation request.

12. The system of claim 11, wherein
each transaction data entry further includes a third data element configured to store a merchant category identifier, and
the one or more transaction behaviors are further based on data stored in the third data element in each transaction data entry included in the associated subset of transaction data entries.

13. The system of claim 12, wherein the merchant category identifier is indicative of at least one of: a parking merchant, a transportation merchant, and a miscellaneous merchant.

14. The system of claim 11, wherein the one or more parking metrics includes at least one of: parking availability, parking search time, and parking cost.

15. The system of claim 11, wherein the one or more transaction behaviors includes at least one of: transaction frequency, parking purchase frequency, transportation purchase frequency, number of transactions, and transaction merchant types.

16. A system for generating data estimates of parking metrics based on transaction behaviors, comprising:
a first database of a processing server configured to store a plurality of parking data correlations, wherein each parking data correlation includes at least one or more parking metrics and one or more correlated transaction behaviors;
a second database of the processing server configured to store a plurality of transaction data entries, wherein each transaction data entry includes data related to a payment transaction including at least a plurality of data elements including at least a first data element configured to store a geographic location and a second data element configured to store a time and/or date;
a receiving device of the processing server configured to receive a parking metric request, wherein the parking metric request includes at least a specific geographic area and a time and/or date range;
a processor of the processing server configured to
execute a first query on the second database to identify a subset of transaction data entries where the included first data element stores a geographic location within the specific geographic area and where the included second data element stores a time and/or date within the time and/or date range,
identify one or more transaction behaviors based on at least a number of transaction data entries included in the identified subset of transaction data entries and data stored in one or more of the plurality of data elements included in each transaction data entry included in the identified subset of transaction data entries, and
execute a second query on the first database to identify a parking data correlation where the included one or more correlated transaction behaviors corresponds to the identified one or more transaction behaviors; and
a transmitting device of the processing server configured to transmit at least the one or more parking metrics included in the identified parking data correlation in response to the received parking metric request.

17. The system of claim 16, wherein
each transaction data entry further includes a third data element configured to store a merchant category identifier, and
the one or more transaction behaviors are further based on data stored in the third data element in each transaction data entry included in the associated subset of transaction data entries.

18. The system of claim 17, wherein the merchant category identifier is indicative of at least one of: a parking merchant, a transportation merchant, and a miscellaneous merchant.

19. The system of claim 16, wherein the one or more parking metrics includes at least one of: parking availability, parking search time, and parking cost.

20. The system of claim 16, wherein the one or more transaction behaviors includes at least one of: transaction frequency, parking purchase frequency, transportation purchase frequency, number of transactions, and transaction merchant types.
